(19) United States
(12) Patent Application Publication
(10) Pub. No.: US 2014/0088994 A1
(43) Pub. Date: Mar. 27, 2014

(54) METHOD AND SYSTEM FOR TREND-BASED PATIENT MANAGEMENT

(71) Applicant: CardioMEMS, Inc, Atlanta, GA (US)

(72) Inventor: Jason Kroh, Atlanta, GA (US)

(73) Assignee: CardioMEMS, Inc, Atlanta, GA (US)

(21) Appl. No.: 14/033,621

(22) Filed: Sep. 23, 2013

Related U.S. Application Data
(60) Provisional application No. 61/703,860, filed on Sep. 21, 2012.

(51) Int. Cl. G06F 19/00

(52) U.S. Cl. CPC G06F 19/345
USPC 705/2

(57) ABSTRACT

The present disclosure is directed to a system having a database operable to receive at least one physiological parameter data from at least one of an electronic medical record (EMR) portal configured for receiving EMR data from an electronic medical record; a healthcare provider (HCP) portal configured for receiving HCP data; a patient portal configured for receiving patient data; and a medical device portal configured for receiving medical device data; for calculating secondary parameters from scoring algorithms, trend algorithms, parameter algorithms and treatment algorithms; then displaying the data and secondary parameters in a graphical format in order to for detect, diagnose and treat chronic disease in patients.

### CROSS-REFERENCE TO RELATED APPLICATIONS

This application claims priority to and the benefit of U.S. Provisional Application Ser. No. 61/703,860, filed on Sep. 21, 2012 and entitled “Method and System for Trend-Based Patient Management,” which application is incorporated in its entirety in this document by reference.

### FIELD OF THE INVENTION

The invention relates generally to systems and methods for detecting, diagnosing and treating chronic disease in patients.

### SUMMARY

It is to be understood that this summary is not an extensive overview of the disclosure. This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

Certain embodiments of the disclosure relate to methods for facilitating trend-based patient management. Such methods can enable tracking of trends of physiological parameters and associating those trends with health-related incidents. In additional or alternative embodiments, such methods can also enable display of physiological information and health-related incidents over a relevant time period to enable more intuitive treatment decision-making and improve management of a given clinical case. Certain other embodiments of the disclosure relate to methods for patient management that allow a treatment provider to define alerts for a given clinical case such that when certain conditions are met, a message is generated and sent to at least one of a treatment provider, a patient and a care provider for that patient to indicate an action, the ultimate end of which is to alter the course of treatment to improve the patient's health.

### DESCRIPTION OF THE DRAWINGS

The accompanying drawings are incorporated and illustrate exemplary embodiment(s) of the disclosure and together with the description and claims appended hereto serve to explain various principles, features, or aspects of the subject disclosure.

FIG. 1 illustrates a block diagram of the present systems and methods.

FIG. 2 illustrates one exemplary aspect of an output of the present systems and methods.

FIG. 3 illustrates another exemplary aspect of an output of the present systems and methods.

FIG. 4 illustrates a computing environment that enables various aspects of treatment planning and/or automation of treatment planning in accordance with aspects described herein.

### DETAILED DESCRIPTION

The subject disclosure may be understood more readily by reference to the following detailed description of exemplary embodiments of the subject disclosure and to the Figures and their previous and following description.

Before the present compounds, compositions, articles, devices, and/or methods are disclosed and described, it is to be understood that the subject disclosure is not limited to specific systems and methods for compensator-based brachytherapy and related devices. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

In the subject specification and in the claims which follow, reference may be made to a number of terms which shall be defined to have the following meanings: “Optional” or “optionally” means that the subsequently described event or circumstance may or may not occur, and that the description includes instances where said event or circumstance occurs and instances where it does not.

As employed in this specification and annexed drawings, the terms “unit,” “component,” “interface,” “system,” “platform,” “stage,” and the like are intended to include a computer-related entity or an entity related to an operational apparatus with one or more specific functionalities, wherein the computer-related entity or the entity related to the operational apparatus can be either hardware, a combination of hardware and software, software, or software in execution. One or more of such entities are also referred to as “functional elements.” As an example, a unit may be, but is not limited to being, a process running on a processor, a processor, an object, an executable computer program, a thread of execution, a program, a memory (e.g., a hard disc drive), and/or a computer. As another example, a unit can be an apparatus with specific functionality provided by mechanical parts operated by electric or electronic circuitry which is operated by a software or a firmware application executed by a processor, wherein the processor can be internal or external to the apparatus and executes at least a part of the software or firmware application. In addition or in the alternative, a unit can provide specific functionality based on physical structure or specific arrangement of hardware elements. As yet another example, a unit can be an apparatus that provides specific functionality through electronic functional elements without mechanical parts, the electronic functional elements can include a processor therein to execute software or firmware that provides at least in part the functionality of the electronic functional elements. An illustration of such apparatus can be control circuitry, such as a programmable logic controller. The foregoing example and related illustrations are but a few examples and are not intended to be limiting. Moreover, while such illustrations are presented for a unit, the foregoing examples also apply to a component, a system, a platform, and the like. It is noted that in certain embodiments, or in connection with certain aspects or features thereof, the terms “unit,” “component,” “system,” “interface,” “platform” can be utilized interchangeably.

Throughout the description and claims of this specification, the words “comprise,” “include,” and “have” and variations of the word, such as “comprising,” “comprises,” “including,” “includes,” “has,” and “having” mean “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Reference will now be made in detail to the various embodiment(s), aspects, and features of the subject disclosure, example(s) of which are illustrated in the accompanying drawings. Wherever possible, the same reference numbers are used throughout the drawings to refer to the same or like parts.

As described in greater detail below, this disclosure relates to systems and methods for facilitating trend-based patient management. Such systems and methods can trend at least one physiological parameter over time and enable association of the at least one physiological parameter trend with health-related incidents comprising at least one of life events, health events, other physiological parameters, and medication changes. In additional or alternative embodiments, such systems and methods can also enable display of the at least one physiological parameter and at least one health-related incident over a relevant time period to enable more intuitive treatment decision-making and improve management of a given clinical case. Certain other embodiments of the disclosure relate to systems and methods for patient management that allow a treatment provider to define alerts for a given clinical case such that when certain conditions are met, a message is generated and sent to at least one of a treatment provider, a patient and a care provider for that patient to indicate an action whose ultimate end is to alter the course of treatment to improve the patient's health.

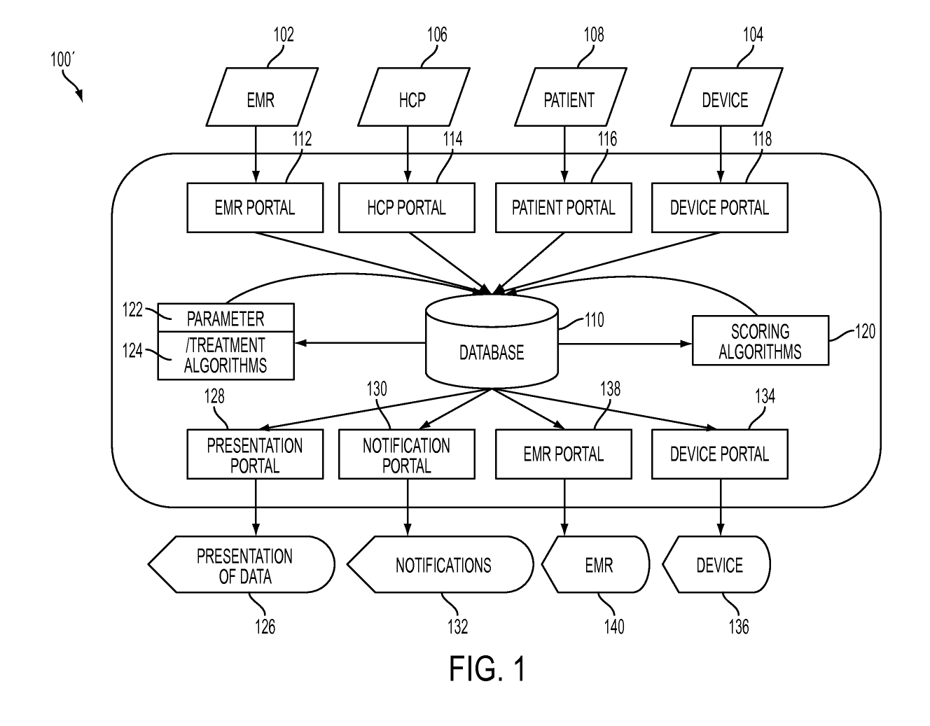

Various aspects or features of the present disclosure relate to systems and methods for facilitating trend-based patient management and are illustrated generally in FIG. 1. Data can be input into a database 110 associated with the system 100 from a variety of sources such as, but not limited to, electronic medical records (EMR) 102, medical devices 104, entry by health care providers 106 and entry by patients or their care providers 108. Each type of data can have a corresponding means for inputting data into the database. For instance, EMR data can be input into the system via an EMR portal 112, healthcare providers can input data into the system via a healthcare provider portal 114, patients can input data into the system through a patient portal 116, medical devices can input data into the system via a medical device portal 118, and the like. In one aspect, each respective data type can be converted to a data type employed by implementations of the present system. Such data types can include, for example and without limitation, XML, JSON and the like. The data can then be stored in the database for subsequent use.

In aspects of the disclosure, the methods and systems herein can be configured to import data from EMR software and, in additional or alternate aspects, to export data to EMR software. In one aspect, data can be imported from EMR software into the present system using an industry standard continuity of care document (CCD). As one skilled in the art will appreciate, the CCD specification can be an XML-based markup standard intended to specify the encoding, structure and semantics of a patient summary clinical document for exchange. The CCD specification can be, in one aspect, a constraint on the HL7 Clinical Document Architecture (CDA) standard. The CDA can specify that the content of the document consists of a mandatory textual part (which ensures human interpretation of the document contents) and optional structured parts (for software processing). The structured part can be based on the HL7 Reference Information Model (RIM) and can provide a framework for referring to concepts from coding systems such as from SNOMED and LOINC. The patient summary can contain a core data set of the most relevant administrative, demographic, and clinical information facts about a patient's healthcare, covering one or more healthcare encounters. A CCD can also provide a means for one healthcare practitioner, system, or setting to aggregate all of the pertinent data about a patient and forward it to another practitioner, system, or setting to support the continuity of care. The primary use of a CCD can be to provide a snapshot in time containing the pertinent clinical, demographic, and administrative data for a specific patient. A more detailed description of CCDs can be found at http://en.wikipedia.org/wiki/Continuity_of Care_Document, which is hereby incorporated by reference in its entirety. In one aspect of the present disclosure, a CCD is transmitted to an email account configured to check for received CCDs and import received CCD information into the database. In another aspect, the CCD can be manually imported by a form provided in a software interface.

In other aspects of the disclosure, the present systems and methods can be configured to connect to EMR software and import data into the database from the EMR software. In one aspect, this data can be imported in response to a direct command by an end user, an event in the patient record of either the EMR or the present system, or a scheduled batching event configured by an end-user. HL7 standards can be used to facilitate this process and are explained in http://en.wikipedia.org/wiki/Health_Level_{—}7 which is hereby incorporated by reference in its entirety. In a further aspect, systems and methods of the present disclosure can be configured to export data to the EMR using similar means as that described supra.

In other aspects of the disclosure, healthcare providers and patients can enter data into implementations of the present systems through a corresponding web-based or web-enabled portal. In one aspect, a web-based or web-enabled portal for healthcare providers can comprise fields to manually enter physiological parameter data, scan items of interest, up-load photographs, and import non-EMR data. In one aspect, a web-based or web-enabled portal for patients can comprise a means for entering information through, for example and without limitation. a questionnaire, free-flow diary, scans of logs, and the like. In certain aspects, the patients can have access to previously entered data and, in alternate aspects, the patients can not have access to previously entered data. In a further aspect, in the case where patients do have access to previously recorded data, that data or information generated based on that data can be transmitted to other non-medical individuals such as family members through e-mail or social media. In other aspects, the healthcare provider can scan and upload data to the web-based portal. In other aspects of the present disclosure, healthcare providers and patients can enter data into web-enabled software applications associated with electronic devices having internet connectivity via, for example and without limitation, Bluetooth, WIFI, Ethernet and the like. In some such aspects, data can be entered into calendar applications, nutritional or dietary log applications, camera applications (with or without OCR), or from custom local applications.

In other aspects of the disclosure, the present methods and systems can be configured to connect to medical devices and import data into the database from the medical device. As one skilled in the art will appreciate, there are many types of medical devices configured to measure physiological parameters such as, for example and without limitation, various blood pressures, weight, blood glucose levels and the like. In one aspect, implementations of the present systems and methods can be configured to communicate with such medical devices. In one aspect, the present systems can be configured to allow the device to interact directly with an application program interface (API) of the database. APIs can include, for example and without limitation, web-based or binary APIs that are available through a network connection to the database. In further aspects, the device can be configured to access to the network by, for example and without limitation, a NIC, WIFI, telephone, cellular modem or the like. In an alternative aspect, devices not configured to interface directly with the database APIs can be further connected to an interface device. In one aspect, the interface device can be configured to enable the device to interface with the database API via a non-network connection such as, for example and without limitation, a serial port, USB port or the like. In a further aspect, the interfacing device can then communicate with the database via the network API over, for example and without limitation, a NIC, WIFI, telephone, cellular modem or the like. In another alternative aspect, communication between implementations of the present systems and a medical device can be enabled via a separate third party database application configured to support the medical device. In this aspect, the third party database can collect the data from the device via, for example, proprietary means and then the present systems can be configured to obtain the data contained in the third party database application over a network link.

In other aspects of the disclosure, the present systems and methods can comprise a database 110 having data structures. In operation, the respective source portals 112, 114, 116, 118 can format the data submitted by the source 102, 104, 106, 108 in a form appropriate for the database. In one aspect, data structures provided for communication with the database can depend upon the types of information being transferred. For example and without limitation, data structures can include XML, JSON or the like. In a further aspect, data structures can be configured to provide fields for the data being transferred from an external source into a database of the present methods and systems. Data can include, for example and without limitation, arrays or scalars for date, time, pressure, weight, blood glucose and the like. In another aspect, the database can be configured to include database queries. Database queries can include, for example and without limitation, SQL, NoSQL, API calls and the like. In other aspect, data output from the database can be generated and sent as requested to, for example and without limitation, present data, provide notifications to changes or alerts, to export data to other systems, to respond to devices and the like.

In yet other aspects of the present disclosure, at least one scoring algorithm 120 can be used to determine the validity of the data input into the database 110. In this aspect, software provided on the database can be configured to score the incoming data based on, for example and without limitation, the physiological improbability, impossibility and the like. The software can be further configured to provide, for example and without limitation, flags, notifications, error messages and the like to indicate to a user that certain data should either be re-entered or verified. In one exemplary aspect, a scoring algorithm 120 can be configured to check individual datum and/or collected data against at least one of physiologically relevant ranges of values and prior physiological data entries to ensure that only correct data is both entered and employed in any further display or analysis of that physiological parameter. In other aspects, scoring algorithms can also be provided and configured to calculate various other parameters indicative of a patient's health and subsequently stored in the database. In operation, the database can be selectively configured to score data. Data to be scored can be sent to the API layer using, for example and without limitation, HTTP, JSON, XML and the like. Subsequently, the data can be placed in a queue to wait for server capacity to become available. At such time, the data can be entered into the database and, next, the scoring algorithm can process the reading to assign a confidence score to the data. In one aspect, the confidence score can be stored in the database. Depending on the confidence score, the system can be configured to take another action such as, for example and without limitation, directing the system to create another job, generating alerts and/or notifications based on the data and the confidence score or a recalculated trend, and the like. The results of the scoring algorithm can be stored as additional data within the database.

In further aspects of the present disclosure, at least one parameter algorithm 122 can be provided. In this aspect, software provided on the database can calculate additional parameters or analyze trends based on at least one type of data. A parameter algorithm 122 can be configured to use at least one physiological parameter datum to calculate at least one further physiological parameter data relevant to the patient's health and the further physiological parameter data can be stored in the database. In a trend algorithm, a health care provider can set alert thresholds for any sort of patient parameter for each individual patient. In one aspect, when the trend passes the healthcare provider-set threshold, the system will generate and deliver an alert to a designated party by, for example and without limitation, e-mail, SMS, push notification, and the like. The values associated with or generated by such treatment and parameter algorithms can be stored as additional data within the database.

In even further aspects of the present disclosure, at least one treatment algorithm 124 can be provided. A treatment algorithm 124 can be configured to use at least one physiological parameter datum to compare against a conditional course of treatment indicated for a patient. In one aspect, a healthcare provider indicates that one action should be taken if the physiological data lies in one range of values and at least one other action that should be taken if the physiological data lies outside that range of values. The action can be, for example and without limitation, continuing or discontinuing a medication, changing the dosage of a medication, indicate the need for clinical evaluation of the patient, and indicate like actions intended to improve the health of the patient.

In various other aspects of the present disclosure, the methods and systems presented herein can provide for presentation of the data collected in the database in the form of a presentation output. Accordingly, in one aspect, a presentation output 126 can comprise a graphical display of selected data. Here, the database can be configured to send selected data through a presentation portal 128 to be displayed on a means for graphically displaying the selected data, for example and without limitation, a closed software, web-based or web-enabled software and the like. The presentation portal is configured to format both the data and the graphical display as the particular presentation output requires. In a further aspect, a graphical display comprises, for example and without limitation, trend graphs, tabs indicating display of different types of information, reports and the like. Presentation output configured for healthcare providers and/or patients can comprise, for example and without limitation, trend graphs, lists of data, notifications, alerts and the like. In a further aspect, the graphical display comprising a presentation output may also provide a means for communication from system users to other system users such as, for example and without limitation, a healthcare provider notice to a patient of medication changes. Such communications can be viewed when a patient accesses, for example and without limitation, software, web-based application and the like to view and/or enter data

In various other aspects, the methods and systems presented herein can also be configured to generate alerts and/or notifications related to the patient's monitored condition or conditions. In one aspect, the alerts and/or notifications can be displayed. Here, the database can be configured to send selected data through a notification portal 130 to a notification-generating means 132 where the data can be further configured and sent to a recipient. In one aspect, an alert/notification means 132 can be configured to generate, for example and without limitation, website notifications, e-mail notifications, text notifications, fax notifications, telephonic notifications, and the like.

In various other aspects, an EMR output portal 134 can be configured to export the data to an EMR 136 by the appropriate means such as those described previously with regard to importing data from EMRs into the present system. In another aspect, the medical device output portal 138 can be configured to format and export data back to a medical device 140 by the appropriate means described previously with regard to importing data from medical devices into the present system and, in a further aspect, displayed by the medical device.

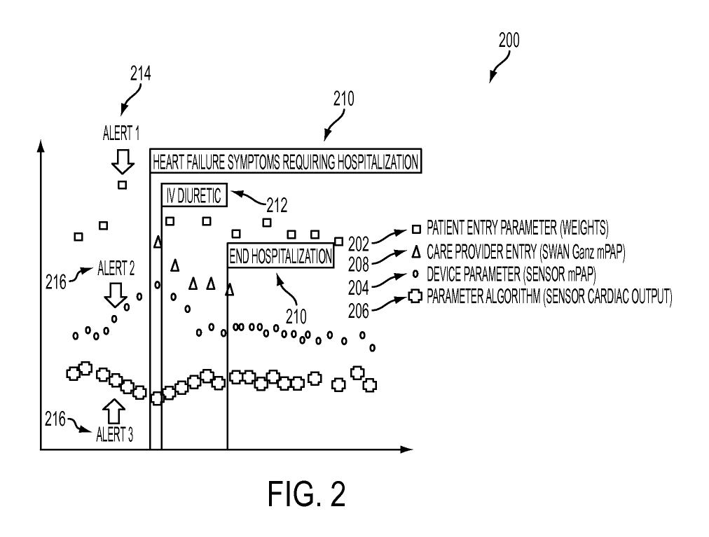

One aspect of the present disclosure illustrated in FIG. 2 shows one example of a presentation output 200. Patient entry parameters 202 may be entered manually by a patient through the patient entry portal. Additionally, time synchronous implant device parameters 204 may be recorded from home based or hospital based devices. Additional parameters 206 may be calculated from the device parameter data 204 and/or patient entry parameter data 202. Flags such as timing of hospitalization 210 and timing of medication changes 212 which can be manually entered by the health care provider or imported through the EMR can be plotted along with the data. Notifications and/or alerts may be provided to the health care provider or to the patient as a result of data exceeding pre-defined thresholds 214 or based on trends 216. A plurality of parameters may be plotted on a time axis to provide the care provider visibility of how a plurality of parameters interact prior to health events of interest such as, for example and without limitation, hospitalizations, symptoms and the like. Additionally, the alerts and the notifications can be used to prevent hospitalizations and/or symptoms by making modifications to medications earlier in the heart failure disease progression.

Various aspects or features of the present disclosure can be especially useful in managing patients with chronic disease. Chronic disease can include conditions such as, but not limited to, asthma, arthritis, heart failure, diabetes, hypertension, epilepsy, hypothyroidism, chronic obstructive pulmonary disorder, chronic renal disease, depression, schizophrenia, attention deficit disorder, bipolar affective disorder and the like. In the present disclosure, heart-related conditions and, specifically, heart failure are discussed but it should be understood that the present systems and methods can be applied to any disease or clinical condition requiring monitoring over time.

The optimum management of patients with chronic diseases can require that therapy be adjusted in response to changes in the patient's condition. In many cases, these changes can be measured by daily patient self-monitoring prior to the development of symptoms. Thus, one or more embodiments of the present invention provide a system configured to enable a treatment provider to track patients' self-monitoring and self-administration of therapy along with physiological information gathered as a result of clinical examination. In further embodiments, the present systems and associated methods form a closed therapeutic loop, creating a dynamic management system for maintaining homeostasis. Such a system can, in the short term, benefit day-to-day symptoms and quality-of-life, and in the long term, prevent progressive deterioration and complications.

In some cases, timely administration of a single dose of a therapy can prevent serious acute changes in a patient's condition. In another cases, interactive physician management strategies can impact both the short and long term sequelae of the disease or condition. For example, a patient can correspondingly adjust their medications according to their physician's prescription and the prescription can be adjusted by the physician based on changes in the patient's underlying condition. With continual monitoring of the subject physiological parameter(s) of interest, changes in disease management can be made by the physician in order to prevent hospitalization or other adverse health events due to symptoms caused by under-treatment and over-treatment.

One example of such a chronic disease is heart failure. There are approximately 5 million patients with symptoms relating to underlying heart damage defining a clinical condition known as heart failure (HF). Although survival rates have improved, the mortality associated with HF remains worse than many common cancers. The number of HF patients is expected to grow to 10 million within the coming decade as the population ages and more people with damaged hearts are surviving. HF is a condition in which a patient's heart works less efficiently than it should, and a condition in which the heart fails to supply the body sufficiently with the oxygen-rich blood it requires, either during exercise or at rest. To compensate for this condition and to maintain blood flow (cardiac output), the body retains sodium and water such that there is a build-up of fluid hydrostatic pressure in the pulmonary blood vessels that drain the lungs. As this hydrostatic pressure overwhelms oncotic pressure and lymph flow, fluid transudates from the pulmonary veins into the pulmonary interstitial spaces, and eventually into the alveolar air spaces. This complication of HF is called pulmonary edema, which can cause shortness of breath, hypoxemia, acidosis, respiratory arrest, and death. Although HF is a chronic condition, the disease often requires acute hospital care. Patients are commonly admitted for acute pulmonary congestion accompanied by serious or severe shortness of breath. Acute care for heart failure accounts for the use of more hospital days than any other cardiac diagnosis, and consumes in excess of 20 billion dollars in the United States annually.

HF is an important example of a medical ailment currently not treated with timely, parameter-driven adjustments of therapy, but one that could potentially benefit greatly from such a strategy. Patients with chronic HF are typically placed on fixed doses of four or five drugs to manage the disease. The drug regimen commonly includes but is not limited to diuretics, vasodilators such as ACE inhibitors or A2 receptor inhibitors, beta-blockers such as Carvedilol, neurohormonal agents such as spironolactone, and inotropic agents usually in the form of cardiac glycosides such as, for example, Digoxin.

It would be far more cost effective, and much better for the patient's health, if chronic HF could be managed and controlled by the routine administration of appropriate outpatient oral drug therapy rather than by hospital treatment upon the manifestation of acute symptoms. As with all drugs, these agents are to be taken in doses sufficient to ensure their effectiveness. Problematically, however, over-treatment can lead to bradycardia, hypotension, renal impairment, hyponatremia, hypokalemia, worsening HF, impaired mental functioning, and other adverse conditions. Adding to the challenge of maintaining proper drug dosage is the fact that the optimal dosage will depend on diet, particularly salt and fluid intake, level of exertion, and other variable factors. Adding further to the problem of managing this condition is the fact that patients frequently miss scheduled doses by forgetting to take pills on time, running out of medications or deciding to stop medications without consulting their physician. It is important, therefore, that the patient's condition be monitored regularly and thoroughly, so that optimal or near optimal drug therapy can be maintained. Furthermore, easily obtained measures of a patient's condition are known, such as weight, peripheral blood pressure, subcutaneous edema, temperature, and subjective measures such as fatigue and shortness of breath.

Various aspects of the present invention include systems and methods capable of trending at least one physiological parameter over time and associating those trends with health-related incidents. Data can comprise the collected measurements of the at least one physiological parameter, the information relating to health-related incidents, and the time and date of each measurement or health-related incident. In at least one aspect, the data can originate from at least one of manual data entry into a database by patients, caregivers or treatment providers, electronic medical record (EMR) data export, or received via a link provided between a medical device and implementations of the present systems and methods. In other aspects, the means for data entry can be a telephone, a computer or any other electronic device capable of communicating data to the database. In other aspects, the at least one physiological parameter can be selected from a group comprising weight, heart rate, systemic blood pressure, pulmonary artery pressures, blood oxygen levels, respiratory rate, creatinine levels, blood urea nitrogen levels, electrolyte levels, brain natriuretic peptide levels, nutritional information, medication dosage, and information derived from implanted medical devices. Such medical devices can include cardioverter defibrillators, cardiac resynchronization devices, scales, blood pressure cuffs, Swan-Gantz catheters and the like. In one exemplary aspect, thoracic impedence can be obtained from patients having a cardioverter defibrillator or cardiac resynchronization therapy device and such measurements can be imported into implementations of the present methods and systems. In other aspects, health-related incidents can be selected from the group comprising at least one of life events; health events including but not limited to hospitalizations; nutritional and dietary compliance information; therapy compliance; exercise routine; other physiological data; scheduled medication changes; and medication changes resulting from at-home dosing or lack thereof. In one aspect, drug titration information can be derived from at least one of scheduled medication changes and medication changes due to patient self-dosing or lack thereof.

In additional or alternative embodiments, such systems and methods can also enable graphical display of at least one physiological parameter and at least one health-related incident over a relevant time period. In a further aspect, at least one health-related incident can be added to the graphical display of the trend of the at least one physiological parameter by a treatment provider. In a further aspect, the graphical display can enable a treatment provider to quickly and visually correlate physiological parameter trends to health-related incidents. This can enable more intuitive treatment decision-making and improve management of a given clinical case. In one example of a display, pulmonary artery pressure is tracked over time and hospitalizations, medication changes (for example, but not limited to, types of medication, dosage and the like), and dietary events are recorded. This can enable a treatment provider to optimize medication titration, therapy, and diet.

In additional or alternative embodiments, systems and methods of the present disclosure can also employ assessment tools and track the results of the assessment over time or relative to at least one physiological parameter. In one aspect, the assessment tool employed can comprise at least one of a quality of life questionnaire, a six-minute walk evaluation, a nutritional assessment, sleep apnea screening assessment, a functional ability assessment, a depression assessment or a NYHA functional class assessment. In a further aspect, the quality of life questionnaire can further comprise at least one of the “Minnesota Living with Heart Failure Questionnaire” or the “Kansas City Cardiomyopathy Questionnaire.”

Certain further embodiments of the disclosure relate to systems and methods for patient management that enable alerts for a given clinical case such that when certain conditions are met, a message is generated and sent to at least one of a treatment provider, a patient and a caretaker to indicate an action for the patient to take, the ultimate end of which is to alter the course of treatment to improve the patient's health. In one aspect, threshold-based notifications can be provided. In another aspect, trend-based notifications can be provided. In other aspects, the notification characteristics can be defined by a treatment provider. In additional or alternative aspects, the notification characteristics can be configured to follow treatment modalities known in the art for a given condition. Particular examples of notifications can include weight gains within a short period such as 1 day which may indicate water retention as a result of heart failure symptoms. As a result of the notification, a health care provider may elect to increase diuretic dosage which will be marked on the trend as an event and then continue to monitor weights. Another additional example of notifications can be based on trends of increasing pulmonary artery mean pressure which may indicate worsening heart failure. Pulmonary artery pressure data may be provided by a right heart catheterization or from an implant.

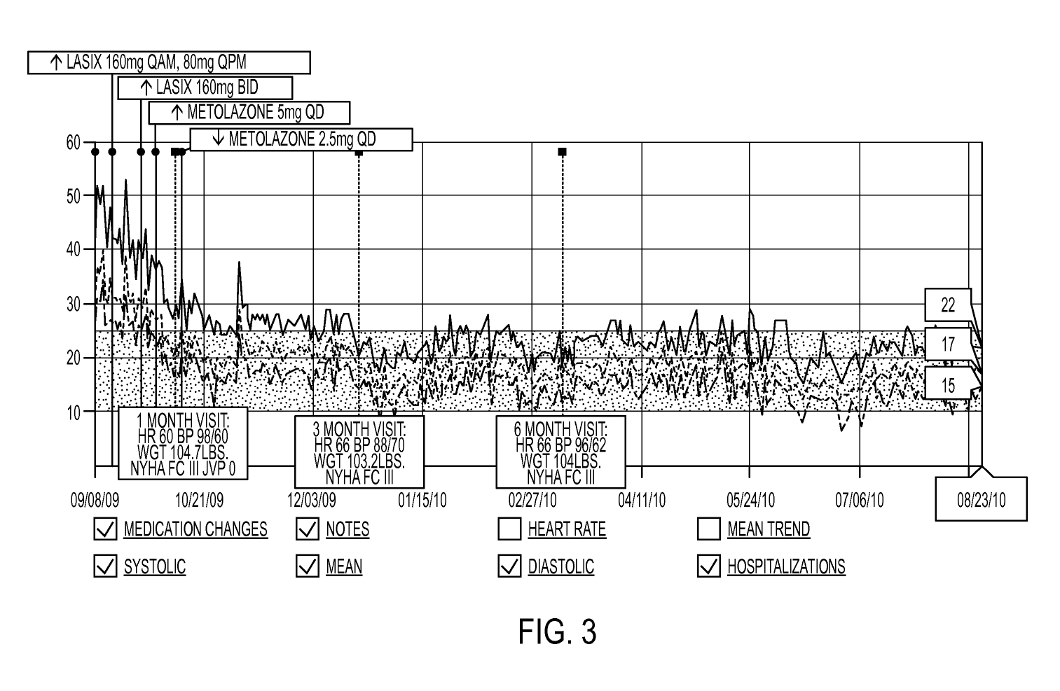

As a result of the notification and as shown in FIG. 3, the health care provider may make modifications to the titration of their heart failure medications or elect to use different forms of medication. The change in medication can be entered as an event and the healthcare provider can continue to monitor patient parameters such as blood pressures subsequent to the medication changes to verify that the change has made an improvement to the patient's condition.

Certain further embodiments of the disclosure relate to systems and methods operable to accept, reject, or flag data input into the system. In one example, the data entered can be rejected or flagged based on physiological impossibility or improbability. In a further aspect, the method can include asking the data entrant to re-enter or verify the data entered to ensure that correct values are recorded into the database. In another aspect, the data can be rejected or flagged based on improbability for the individual patient (for example, systolic systemic pressure under 100 for a hypertensive patient or weight gains of greater than 20%). Individual assessments of the data can be a determined from physiologically large abrupt changes, large unusual deviations from trends, negative or zero values, or comparison of other related parameters which make the particular entry suspect.

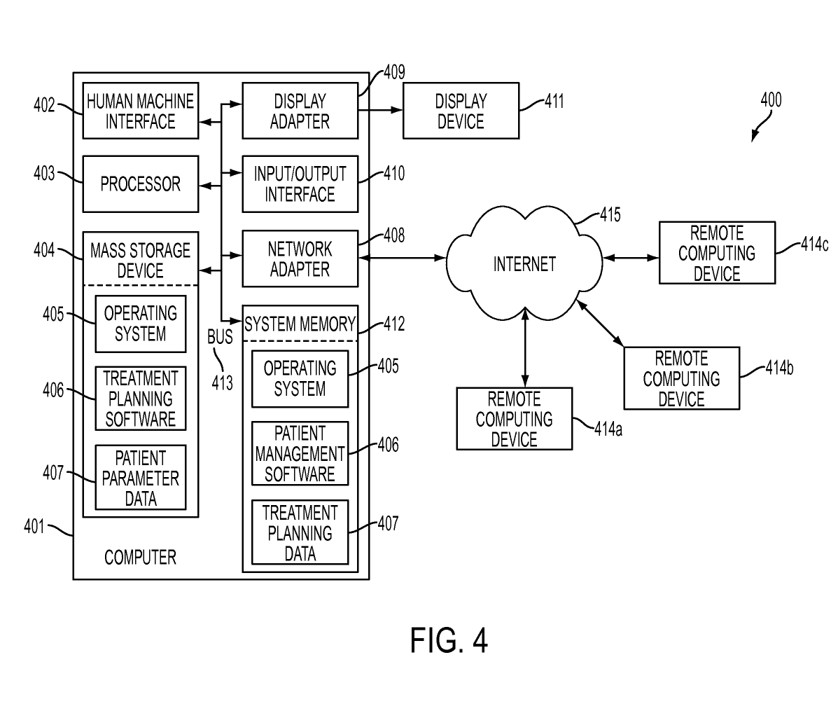

FIG. 4 illustrates a block diagram of an exemplary operating environment 400 that enables various features of the subject disclosure and performance of the various methods disclosed herein. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The various embodiments of the subject disclosure can be operational with numerous other general purpose or special purpose computing system environments or configurations. Examples of well-known computing systems, environments, and/or configurations that can be suitable for use with the systems and methods comprise, but are not limited to, personal computers, server computers, laptop devices or handheld devices, and multiprocessor systems. Additional examples comprise wearable devices, mobile devices, set top boxes, programmable consumer electronics, network PCs, minicomputers, mainframe computers, distributed computing environments that comprise any of the above systems or devices, and the like.

The processing effected in the disclosed systems and methods can be performed by software components. The disclosed systems and methods can be described in the general context of computer-executable instructions, such as program modules, being executed by one or more computers or other computing devices. Generally, program modules comprise computer code, routines, programs, objects, components, data structures, etc. that perform particular tasks or implement particular abstract data types. The disclosed methods also can be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 401. The components of the computer 401 can comprise, but are not limited to, one or more processors 403, or processing units 403, a system memory 412, and a system bus 413 that couples various system components including the processor 403 to the system memory 412. In the case of multiple processing units 403, the system can utilize parallel computing.

In general, a processor 403 or a processing unit 403 refers to any computing processing unit or processing device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally or alternatively, a processor 403 or processing unit 403 can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors or processing units referred to herein can exploit nano-scale architectures such as, molecular and quantum-dot based transistors, switches and gates, in order to optimize space usage or enhance performance of the computing devices that can implement the various aspects of the subject disclosure. Processor 403 or processing unit 403 also can be implemented as a combination of computing processing units.

The system bus 413 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 413, and all buses specified in this description also can be implemented over a wired or wireless network connection and each of the subsystems, including the processor 403, a mass storage device 404, an operating system 405, patient management software 406, patient parameter data 407, a network adapter 408, system memory 412, an Input/Output Interface 410, a display adapter 409, a display device 411, and a human machine interface 402, can be contained within one or more remote computing devices 414 a,b,c at physically separate locations, connected through buses of this form, in effect implementing a fully distributed system.

In one aspect, patient management software 406 can comprise computer-executable instructions for implementing the various methods described herein, such as the exemplary methods disclosed in conjunction with FIG. 2 and FIG. 3. In another aspect, patient management software 406 can include software to control various aspects of manufacturing of the radiation compensator and, as part of manufacturing, treating a surface in accordance with aspects described herein in order to attain a desired thickness profile for the surface of the radiation compensator. In certain embodiments, patient management software 406 also can include computer-executable instruction for selecting radiopaque materials for manufacturing the radiation compensator. Patient management software 406 and patient parameter data 407 configure processor 403 to perform the one or more steps of the methods described herein. In addition or in the alternative, patient management software 406 and patient parameter data 407 can configure processor 403 to operate in accordance with various aspects of the subject disclosure.

The computer 401 typically comprises a variety of computer readable media. Exemplary readable media can be any available media that is accessible by the computer 401 and comprises, for example and not meant to be limiting, both volatile and non-volatile media, removable and non-removable media. The system memory 412 comprises computer readable media in the form of volatile memory, such as random access memory (RAM), and/or non-volatile memory, such as read only memory (ROM). The system memory 412 typically contains data and/or program modules such as operating system 405 and patient management software 406 that are immediately accessible to and/or are presently operated on by the processing unit 403. Operating system 405 can comprise an OS such as Windows operating system, Unix, Linux, Symbian, Android, iOS, Chromium, and substantially any operating system for wireless computing devices or tethered computing devices.

In another aspect, the computer 401 also can comprise other removable/non-removable, volatile/non-volatile computer storage media. By way of example, FIG. 4 illustrates a mass storage device 404 which can provide non-volatile storage of computer code, computer readable instructions, data structures, program modules, and other data for the computer 401. For example and not meant to be limiting, a mass storage device 404 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 404, including by way of example, an operating system 405, and patient management software 406. Each of the operating system 405 and patient management software 406 (or some combination thereof) can comprise elements of the programming and the patient management software 406. Data and code (e.g., computer-executable instruction(s)) can be retained as part of patient management software 406 and can be stored on the mass storage device 404. Patient management software 406, and related data and code, can be stored in any of one or more databases known in the art. Examples of such databases comprise, DB2®, Microsoft® Access, Microsoft® SQL Server, Oracle®, mySQL, PostgreSQL, and the like. Further examples include membase databases and flat file databases. The databases can be centralized or distributed across multiple systems.

In another aspect, the user can enter commands and information into the computer 401 via an input device (not shown). Examples of such input devices comprise, but are not limited to, a camera; a keyboard; a pointing device (e.g., a “mouse”); a microphone; a joystick; a scanner (e.g., barcode scanner); a reader device such as a radiofrequency identification (RFID) readers or magnetic stripe readers; gesture-based input devices such as tactile input devices (e.g., touch screens, gloves and other body coverings or wearable devices), speech recognition devices, or natural interfaces; and the like. These and other input devices can be connected to the processing unit 403 via a human machine interface 402 that is coupled to the system bus 413, but can be connected by other interface and bus structures, such as a parallel port, game port, an IEEE 1394 Port (also known as a Firewire port), a serial port, or a universal serial bus (USB).

In yet another aspect, a display device 411 also can be connected to the system bus 413 via an interface, such as a display adapter 409. It is contemplated that the computer 401 can have more than one display adapter 409 and the computer 401 can have more than one display device 411. For example, a display device can be a monitor, an LCD (Liquid Crystal Display), or a projector. In addition to the display device 411, other output peripheral devices can comprise components such as speakers (not shown) and a printer (not shown) which can be connected to the computer 401 via Input/Output Interface 410. Any step and/or result of the methods can be output in any form to an output device. Such output can be any form of visual representation, including, but not limited to, textual, graphical, animation, audio, tactile, and the like.

The computer 401 can operate in a networked environment using logical connections to one or more remote computing devices 414 a,b,c. By way of example, a remote computing device can be a personal computer, portable computer, a mobile telephone, a server, a router, a network computer, a peer device or other common network node, and so on. Logical connections between the computer 401 and a remote computing device 414 a,b,c can be made via a local area network (LAN) and a general wide area network (WAN). Such network connections can be through a network adapter 408. A network adapter 408 can be implemented in both wired and wireless environments. Such networking environments are conventional and commonplace in offices, enterprise-wide computer networks, intranets, and the Internet. Networking environments are referred to as network(s) 415 and generally can be embodied in wireline networks or wireless networks (e.g., cellular networks, such as Third Generation (3G) and Fourth Generation (4G) cellular networks, facility-based networks (femtocell, picocell, Wi-Fi networks, etc.).

As an illustration, application programs and other executable program components such as the operating system 405 are illustrated herein as discrete blocks, although it is recognized that such programs and components reside at various times in different storage components of the computing device 401, and are executed by the data processor(s) of the computer. An implementation of patient management software 406 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer-readable media can comprise “computer storage media,” or “computer-readable storage media,” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

In various embodiments, the disclosed systems and methods for CBT can employ artificial intelligence (Al) techniques such as machine learning and iterative learning for identifying patient-specific, treatment-specific compensators. Examples of such techniques include, but are not limited to, expert systems, case based reasoning, Bayesian networks, behavior based Al, neural networks, fuzzy systems, evolutionary computation (e.g., genetic algorithms), swarm intelligence (e.g., ant algorithms), and hybrid intelligent systems (e.g., Expert inference rules generated through a neural network or production rules from statistical learning).

While the systems, devices, apparatuses, protocols, processes, and methods have been described in connection with exemplary embodiments and specific illustrations, it is not intended that the scope be limited to the particular embodiments set forth, as the embodiments herein are intended in all respects to be illustrative rather than restrictive.

Unless otherwise expressly stated, it is in no way intended that any protocol, procedure, process, or method set forth herein be construed as requiring that its acts or steps be performed in a specific order. Accordingly, in the subject specification, where description of a process or method does not actually recite an order to be followed by its acts or steps or it is not otherwise specifically recited in the claims or descriptions of the subject disclosure that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification or annexed drawings, or the like.

It will be apparent to those skilled in the art that various modifications and variations can be made in the subject disclosure without departing from the scope or spirit of the subject disclosure. Other embodiments of the subject disclosure will be apparent to those skilled in the art from consideration of the specification and practice of the subject disclosure as disclosed herein. It is intended that the specification and examples be considered as non-limiting illustrations only, with a true scope and spirit of the subject disclosure being indicated by the following claims.

We claim:

1. A system comprising:
a database operable to receive at least one physiological parameter data from at least one of:
an electronic medical record (EMR) portal configured for receiving EMR data from an electronic medical record and formatting the EMR data in a system data structure
a healthcare provider (HCP) portal configured for receiving HCP data and formatting the HCP data in the system data structure;
a patient portal configured for receiving patient data and formatting the patient data in the system data structure; and
a medical device portal configured for receiving medical device data and formatting the medical device data in the system data structure,
to determine at least one secondary data from the at least one physiological parameter data using at least one of a scoring algorithm, a parameter algorithm and a treatment algorithm to derive at least one secondary data from the at least one physiological parameter data; and
to store the at least one physiological parameter data and the at least one secondary data; and to output at least one of the at least one physiological parameter data and at least one secondary data to at least one of a presentation portal, a notification portal, a patient portal and a device portal.

2. The system of claim 1, wherein the at least one physiological parameter data is selected from the group comprising an array and a scalar.

3. The system of claim 2, wherein the at least one physiological parameter data comprises at least one of date, time, pressure, weight, and blood glucose level.

4. The system of claim 1, wherein the system data structure can be selected from the group comprising XML and JSON.

5. The system of claim 1, wherein the EMR portal imports EMR data into the system using a continuity of care document specification.

6. The system of claim 1, wherein the system is further configured to export data to at least one electronic medical record.

7. The system of claim 1, wherein the patient portal is a web-based portal configured for manual entry of data.

8. The system of claim 1, wherein the HCP portal is a web-based portal configured for manual entry of data.

9. The system of claim 1, wherein the scoring algorithm is operable to validate the at least one physiological parameter data against at least one of a physiologically relevant range of values and at least one prior physiological data entry.

10. The system of claim 1, further comprising at least one parameter algorithm configured to use at least one of the at least one physiological parameter data to derive a second physiological parameter data.

11. The system of claim 11, wherein the at least one treatment algorithm is configured to compare the at least one physiological parameter datum against a predetermined conditional course of treatment for a patient and output predetermined treatment instructions based thereon.

12. The system of claim 11, wherein the presentation portal comprises a means for graphically displaying the data.

13. A method comprising:
providing data from at least one of an electronic medical record, a healthcare provider, a patient, and a medical device,
formatting the data in a system data structure,
using a scoring algorithm to calculate a result to determine the validity of the data,
storing the data in a system database;
storing the result of the scoring algorithm in the database;
sending the data to at least one of a presentation portal, a notification portal, a electronic medical record portal and a device portal for display.
